(19) United States
(12) Patent Application Publication
(10) Pub. No.: US 2014/0014683 A1
(43) Pub. Date: Jan. 16, 2014

(54) HOT MELT DISPENSING UNIT AND METHOD WITH INTEGRATED FLOW CONTROL

(71) Applicants: Jeffrey E. Owen, Suwanee, GA (US); Michael A. Fornes, Cumming, GA (US)

(72) Inventors: Jeffrey E. Owen, Suwanee, GA (US); Michael A. Fornes, Cumming, GA (US)

(73) Assignee: NORDSON CORPORATION, Westlake, OH (US)

(21) Appl. No.: 13/548,548

(22) Filed: Jul. 13, 2012

(51) Int. Cl. B67D 1/00; B67D 7/80

(52) U.S. Cl. 222/54; 222/146.5

(57) ABSTRACT

A hot melt adhesive dispensing unit includes an adhesive supply for receiving solid or semi-solid hot melt adhesive material, an adhesive supply heater associated with the adhesive supply for melting the solid or semi-solid hot melt adhesive material into a liquid hot melt adhesive material, a manifold connected to the adhesive supply, a pump connected to the manifold for pumping the liquid hot melt adhesive from the adhesive supply into the manifold, a controller connected to the adhesive supply heater and the pump, and a user interface connected to the controller. The user interface is for providing information about and control over heating and pumping functions of the hot melt adhesive dispensing unit, and the controller controls the adhesive supply heater and the pump.

### FIELD OF THE INVENTION

The present invention generally relates to hot melt adhesive dispensing equipment, and more particularly to controllers used in association with heaters and pumps in hot melt adhesive dispensing systems.

### BACKGROUND

Hot melt adhesive systems have many applications in manufacturing and packaging. For example, thermoplastic hot melt adhesives are used for carton sealing, case sealing, tray forming, pallet stabilization, nonwoven applications including diaper manufacturing, and many other applications. Typically, hot melt adhesives are contained in or provided from an adhesive supply, such as a tank or hopper of an adhesive melter. The hot melt adhesive is heated, melted, and pumped to a dispenser, such as a dispensing gun or other applicator which applies the hot melt adhesive to a carton, case, or other objects or substrates. For the adhesive supply, different types of melters have been developed, including tank-style melters and grid and reservoir melters. In a tank-style melter, heaters heat one or more surfaces of the tank and the hot melt adhesives inside the tank. In a grid and reservoir melter, hot melt adhesive moving through a tank or hopper heats on a grid heater and melts as it passes from the grid into a reservoir, which is also heated. Manifolds are used to direct liquid hot melt adhesive into plural flow streams for output through hoses to dispensers. Heaters are typically thermally connected to several components of a hot melt adhesive system, including the adhesive supply (such as a tank, grid, reservoir), manifold, hoses, and dispenser. The heaters maintain the hot melt adhesive at proper adhesive viscosity and temperature.

In addition, different types of pumps have been developed for use in hot melt adhesive systems. Piston pumps, for example, use a piston to move a hydraulic plunger, which drives liquid hot melt adhesive through the hot melt adhesive system. And gear pumps employ counter-rotating gears to create positive displacement for precise metering of liquid hot melt adhesive. Pumps move the liquid hot melt adhesive through the hot melt adhesive system, including through the hoses and to the dispenser for application to an object.

Controllers associated with heaters vary from simple systems to more complex, programmable systems that monitor and control multiple temperature zones throughout the hot melt adhesive system. Heater controllers are typically associated with at least one user interface for allowing a user to control or adjust heating functions.

Controllers associated with pumps similarly vary from simple systems to more complex systems, such as closed loop feedback systems that control and adjust pump speed in response to hot melt adhesive output flow rates. A typical closed loop feedback system measures the rate of hot melt adhesive flowing through the hot melt adhesive system and provides the flow rate information to a pump controller. Based on the measured flow rate information, the pump controller adjusts the pump speed to achieve a flow rate that more closely matches a target flow rate. Pump controllers are typically associated with at least one user interface for allowing a user to control or adjust pumping functions.

A separate user interface is associated with the heater controller and the pump controller and a user is required to interact with each user interface separately. Where the user interfaces are physically distant from one another, the user is required to move between them to interact with them. Also, each user interface occupies an amount of space in a hot melt adhesive system and contributes to the total cost thereof.

There is a need, therefore, for a hot melt adhesive dispensing system and method that address one or more of the shortcomings discussed above.

### SUMMARY OF THE INVENTION

Embodiments of the present invention are directed to hot melt adhesive dispensing units that include a single controller for controlling both heating and pumping of the hot melt adhesive, and a single user interface associated with the controller.

According to one embodiment of the invention, a hot melt adhesive dispensing unit includes an adhesive supply for receiving solid or semi-solid hot melt adhesive material, an adhesive supply heater associated with the adhesive supply for melting the solid or semi-solid hot melt adhesive material into a liquid hot melt adhesive material, a manifold connected to the adhesive supply, a pump connected to the manifold for pumping the liquid hot melt adhesive from the adhesive supply into said manifold, a controller connected to the adhesive supply heater and the pump, and a user interface connected to the controller. The user interface is for providing information about and control over heating and pumping functions of the hot melt adhesive dispensing unit, and the controller controls the adhesive supply heater and the pump.

According to another embodiment of the invention, a method is provided for controlling the heating and pumping features of the hot melt adhesive in a hot melt adhesive dispensing unit that includes a heater for heating the hot melt adhesive, a pump for distributing the hot melt adhesive, a controller connected to the heater and the pump for controlling the heater and the pump, and a user interface connected to the controller. The method includes using the user interface to send temperature control instructions to the controller, using the user interface to send pump control instructions to the controller, sending temperature control instructions from the controller to the heater for adjusting the temperature of the heater, and sending pump control instructions from the controller to the pump for adjusting the speed of the pump.

By combining the features for controlling both the heating and pumping features of a hot melt adhesive dispensing unit into a single controller, separate controllers are unnecessary. Also, a single user interface is used in association with the single controller, making separate user interfaces unnecessary. Consolidating control functions and user interfaces presents advantages, including cost-savings and space-savings.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view in partial cross-section of a hot melt adhesive system.

FIG. 2 is a schematic representation depicting features relating to the controller of the hot melt adhesive system of FIG. 1.

### DETAILED DESCRIPTION OF THE ILLUSTRATIVE EMBODIMENTS

Referring to the figures, features of the present invention are shown in the context of a hot melt adhesive system 10. It will be appreciated that the hot melt adhesive system 10 shown and described herein is merely exemplary, and that the present invention is equally applicable to other hot melt adhesive systems. For example, the hot melt adhesive system 10 includes a tank-style melter as an adhesive supply, but the invention is also applicable to a hot melt adhesive system that includes a grid and reservoir melter.

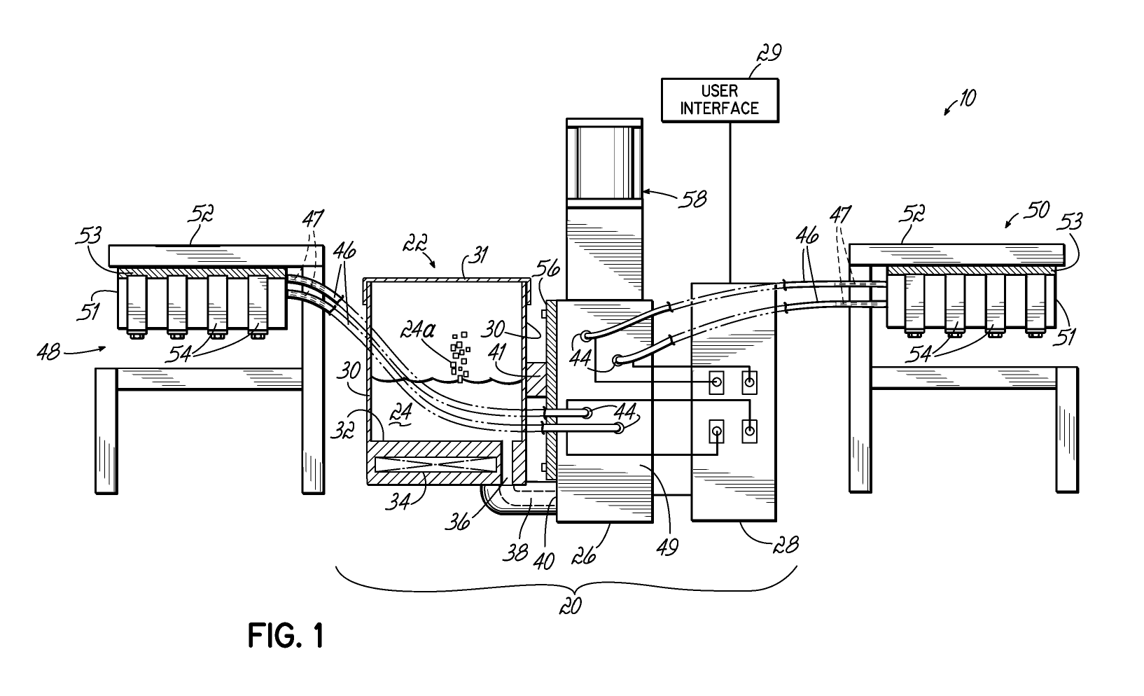

As best seen in FIG. 1, the hot melt adhesive system 10 includes a dispensing unit 20 that includes an adhesive supply 22 (a tank) for receiving and melting solid or semi-solid hot melt adhesive material 24a, a manifold 26 connected to the adhesive supply 22, a controller 28, and a user interface 29. Upon melting, the solid or semi-solid hot melt adhesive material 24a transforms into a liquid hot melt adhesive material 24. The adhesive supply 22 comprises side walls 30, a removable cover 31, and base 32 which includes one or more adhesive supply heaters 34 for melting and heating the hot melt adhesive material 24a and the liquid hot melt adhesive material 24 in the adhesive supply 22. The base 32 is integral with the adhesive supply 22 and contains one or more heaters 34. An outlet 36 proximate the base 32 is connected to a passage 38 which connects to an inlet 40 of the manifold 26.

As shown, the manifold 26 is mounted to a side wall 30 of the adhesive supply 22 with a spacer 41 separating the adhesive supply 22 and manifold 26. In the embodiment shown, the spacer 41 is made from aluminum to allow heat conduction. A vertically-oriented piston pump 58 is connected to the manifold 26 for pumping liquid hot melt adhesive material 24 from the adhesive supply 22 and into the manifold 26 where it is split into separate flows. The manifold 26 includes a plurality of outlet ports 44 that are fitted with heated hoses 46 attached to one or more adhesive guns 48, 50 to supply the liquid hot melt adhesive material 24 to the guns 48, 50. Each heated hose 46 is thermally connected to a hose heater 47.

The guns 48, 50 may include one or more adhesive dispensing modules 54 for dispensing/applying the hot melt adhesive 24 to an object (not shown). The adhesive dispensing modules 54 are mounted to gun bodies 51 having gun heaters 53 and are supported on a frame 52. The hot melt adhesive system 10 shown in FIG. 1 includes two guns 48, 50, one located on each side of the dispensing unit 20, although different numbers of guns, dispensing modules, and other configurations may also be used.

The manifold 26 includes a manifold heater 56 separate from the adhesive supply heater 34 and which can be independently controlled by the controller 28. Of course, it will be appreciated that a single heater could also be used for heating the adhesive supply 22 and the manifold 26.

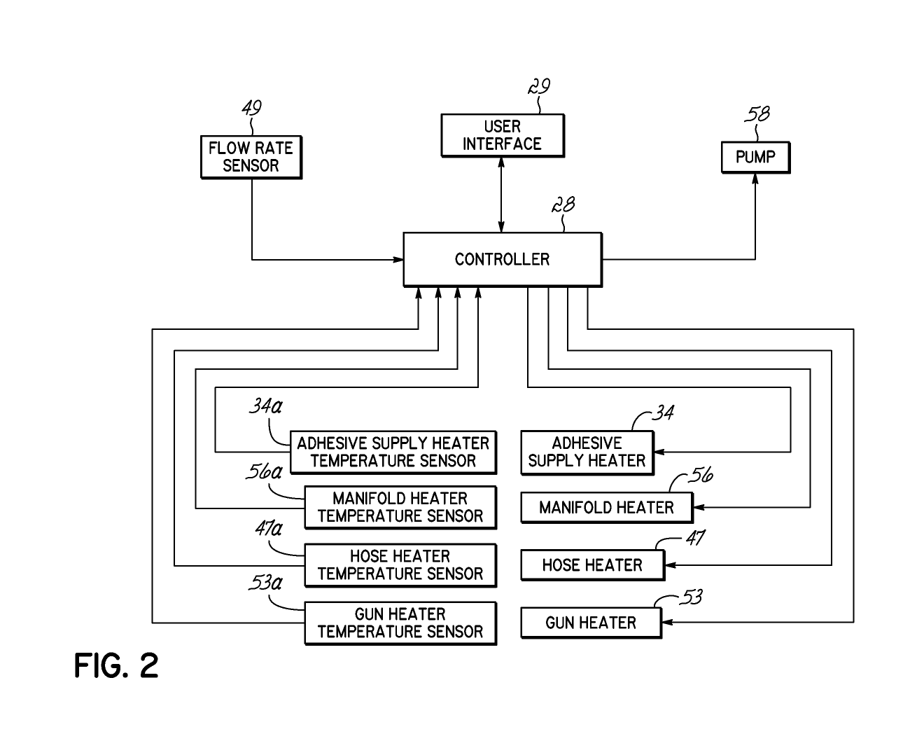

Each of the adhesive supply heater 34, the hose heaters 47, the gun heaters 53, and the manifold heater 56 are associated with a temperature sensor 34a, 47a, 53a, and 56a, respectively, which are not illustrated in FIG. 1 but the temperature sensors 34a, 47a, 53a, and 56a are shown in communication with the controller 28 in FIG. 2. The temperature sensors 34a, 47a, 53a, and 56a are for sensing the temperature of the liquid hot melt adhesive material 24 and may include resistive thermal devices or any other suitable device for measuring temperature.

The hot melt adhesive system 10 also includes one or more flow sensors for measuring the rate of movement, or flow, of the liquid hot melt adhesive material 24 flowing through the various components of the hot melt adhesive system 10. As shown in FIG. 1, a flow sensor 49 is incorporated into the manifold 26, but it will be appreciated that a flow sensor could also be incorporated into the heated hoses 46, the guns 48, 50, or at another location where the liquid hot melt adhesive material 24 flows generally between the manifold 26 and the point of application to the object.

The user interface 29 provides a user with information about, and control over, aspects of the hot melt adhesive system 10. The user interface 29 is connected with the controller 28. For example, the user interface 29 presents information relating to a desired hot melt adhesive temperature, the temperature of the heaters 34, 47, 53, and 56, hot melt adhesive flow rate, pump speed, and the like. The user interface 29 may also include controls for adjusting any parameter of the hot melt adhesive system, such as adjusting a desired hot melt adhesive temperature or a hot melt adhesive flow rate. Particularly, the user interface 29 allows a user to control the heating and pumping functions of the hot melt adhesive system 10. The user interface 29 is used to send temperature control instructions and pump control instructions to the controller 28.

The controller 28 includes the power supply and electronic controls for the hot melt adhesive system 10. In particular, the controller 28 includes components for controlling both the heating and pumping functions of the dispensing unit 20.

With respect to the heating functions, the controller 28 is electrically connected to the heaters, including the adhesive supply heater 34, the hose heaters 47, the gun heaters 53 and the manifold heater 56. Using the temperature information provided by the temperature sensors 34a, 47a, 53a, and 56a, the controller 28 independently monitors and adjusts the adhesive supply heater 34, the hose heaters 47, the gun heaters 53, and the manifold heater 56, to melt solid or semi-solid hot melt adhesive 24a received in the adhesive supply 22 and to maintain the temperature of (melted) liquid hot melt adhesive material 24 to ensure proper viscosity of the liquid hot melt adhesive material 24 supplied to the guns 48, 50 and dispensed by the adhesive dispensing modules 54. Generally, and with reference to FIG. 2, the controller 28 receives temperature information from the temperature sensors 34a, 47a, 53a, and 56a and sends heater temperature control instructions, such as for independently controlling any or all of the heaters in the hot melt adhesive system 10, including the adhesive supply heater 34, the hose heaters 47, the gun heaters 53, and the manifold heater 56. Particularly, the temperature of any or all of the heaters in the hot melt adhesive system 10 can be adjusted so the temperature information received by the controller 28 from the associated temperature sensors approximates a desired temperature. Thus, the controller 28 adjusts, such as by increasing or decreasing, the temperature of the adhesive supply heater 34, the hose heaters 47, the gun heaters 53, and the manifold heater 56.

For example, at start-up, controller 28 sends individual heater temperature control instructions to each of the adhesive supply heater 34, the hose heaters 47, and the manifold heater 56 so those components increase their temperature to predetermined set point temperatures, such as generally between 350° F. and 400° F., for example. When the temperatures of these components near their respective set point temperatures, as communicated to the controller 28 through the temperature sensors 34a, 47a, and 56a, the controller 28 energizes the gun heaters 53 and the controller 28 begins to cycle the adhesive supply heater 34, the hose heaters 47, the gun heaters 53, and the manifold heater 56, respectively, on and off to generally maintain their set point temperature. In this manner, the controller 28 provides a smooth increase to operating temperature which is then held throughout operation of the dispensing unit 20 by the controller 28 cycling the respective heaters on and off to maintain respective set point temperatures.

When new hot melt adhesive material 24a is added to the adhesive supply 22, the controller 28 senses a drop in temperature (such as through the temperature information provided by temperature sensor 34a) and the adhesive supply heater 34 is cycled on to increase the temperature and melt the newly added hot melt adhesive 24a, while the manifold 26, the heated hoses 46, and the adhesive guns 48, 50 are maintained at substantially constant temperature by the controller 28. Individual control of the temperature of the liquid hot melt adhesive material 24 in each component, as described above, ensures that liquid hot melt adhesive material 24 is provided to the adhesive dispensing modules 54 at an appropriate application temperature and viscosity without exposing the liquid hot melt adhesive material 24 to excessive temperatures which could overheat and char or otherwise degrade the liquid hot melt adhesive material 24.

With respect to the pumping functions, the controller 28 is electrically connected to the pump 58, and is capable of providing functions of a closed loop flow rate feedback system for adjusting the pump 58 so the flow rate of liquid hot melt adhesive material 24 closely matches a desired flow rate. It will be appreciated that if a hot melt adhesive system includes more than one pump, the controller 28 may also be electrically connected to and control each pump. The controller 28 is also connected to the one or more flow sensors, including the flow sensor 49. The controller 28 monitors the flow rate of liquid hot melt adhesive material 24 and adjusts the pump 58 to ensure proper flow of the liquid hot melt adhesive material 24 through the manifold 26, through the heated hoses 46, supplied to the guns 48, 50, and dispensed by the adhesive dispensing modules 54. Generally, and with reference to FIG. 2, the controller 28 receives flow rate information from the flow sensor 49 and sends pump control instructions to control the pump 58. Thus, the controller 28 adjusts, such as by increasing or decreasing, the speed or output of the pump 58, thereby causing an adjustment of the flow rate of the liquid hot melt adhesive material 24. In particular, the flow rate of the liquid hot melt adhesive material 24 in the hot melt adhesive system 10 may be adjusted to achieve a flow rate that closely matches a desired flow rate, such as what might be set by a user. And by measuring the flow rate and adjusting the pump in view of the measured flow rate, the controller 28 provides a closed-loop flow rate feedback system.

For example, the flow rate of liquid hot melt adhesive material 24 through the hot melt adhesive system 10 may be associated with particular known pump speeds. During operation, the controller 28 sends pump control instructions to the pump 58 so that it operates at a pump speed associated with a desired flow rate. In addition, the controller 28 senses a flow rate of the hot melt adhesive through flow rate information provided by the flow rate sensor 49, and sends pump control instructions to the pump 58 to adjust its pump speed so that the measured flow rate of the liquid hot melt adhesive material 24 more closely matches a desired flow rate.

By combining the features for controlling both the heating and pumping functions of the dispensing unit 20, a single controller 28 is used. Thus, separate controllers for the heaters and the pumps are unnecessary. Also, a single user interface is used in association with the hot melt adhesive system 10 and separate user interfaces for the heat control and the pump control are unnecessary. This consolidation of control functions and user interfaces presents cost-savings and space-savings in a hot melt adhesive system. And, by combining the controls of both the heating and pumping functions, a user can more readily control the hot melt adhesive system 10. For example, a user can interact with a single user interface at a single location and not be required to move between or interact with separate user interfaces.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A hot melt adhesive dispensing unit comprising:
an adhesive supply for receiving solid or semi-solid hot melt adhesive material,
an adhesive supply heater associated with said adhesive supply for melting the solid or semi-solid hot melt adhesive material into a liquid hot melt adhesive material,
a manifold connected to said adhesive supply,
a pump connected to said manifold for pumping the liquid hot melt adhesive from said adhesive supply into said manifold,
a controller connected to said adhesive supply heater and said pump, and
a user interface connected to said controller for providing information about and control over heating and pumping functions of the hot melt adhesive dispensing unit, and wherein
said controller controls said adhesive supply heater and said pump.

2. The hot melt adhesive dispensing unit of claim 1, further comprising a temperature sensor for sensing the temperature of the liquid hot melt adhesive and connected to said controller and a flow rate sensor for measuring a flow rate of the liquid hot melt adhesive and connected to said controller, and wherein
said controller receives temperature information from said temperature sensor and flow rate information from said flow rate sensor, and sends temperature control instructions to said adhesive supply heater for adjusting the temperature of said adhesive supply heater and pump control instructions to said pump for adjusting the speed of said pump so the flow rate approximates a desired flow rate.

3. The hot melt adhesive dispensing unit of claim 2, further comprising a manifold heater associated with said manifold,
wherein said manifold heater is connected to and controlled by said controller.

4. The hot melt adhesive dispensing unit of claim 3, further comprising a heated hose connected to said manifold and a dispensing gun connected to said heated hose, said heated hose including a hose heater and said dispensing gun including a gun heater,
wherein said controller sends temperature control instructions to said hose heater and said gun heater.

5. The hot melt adhesive dispensing unit of claim 4, wherein said controller sends temperature control instructions to said hose heater and said gun heater independently from the temperature control instructions sent to said manifold heater and said adhesive supply heater.

6. The hot melt adhesive dispensing unit of claim 2, wherein said controller provides a closed-loop flow rate feedback system.

7. A method of controlling the heating and pumping features of the hot melt adhesive in a hot melt adhesive dispensing unit comprising a heater for heating the hot melt adhesive, a pump for distributing the hot melt adhesive, a controller connected to the heater and the pump for controlling the heater and the pump, and a user interface connected to the controller, the method comprising:
using the user interface to send temperature control instructions to the controller,
using the user interface to send pump control instructions to the controller,
sending temperature control instructions from the controller to the heater for adjusting the temperature of the heater, and
sending pump control instructions from the controller to the pump for adjusting the speed of the pump.

8. The method of claim 7, further comprising:
collecting temperature information in the controller, and
collecting flow rate information in the controller.

9. The method of claim 8, further comprising adjusting the speed of the pump so the flow rate information approximates a desired flow rate.

10. The method of claims 8, further comprising adjusting the temperature of the heater so the temperature information approximates a desired temperature.

11. The method of claim 9, further comprising adjusting the temperature of the heater so the temperature information approximates a desired temperature.
